(19) United States
(12) Patent Application Publication
(10) Pub. No.: US 2021/0241678 A1
(43) Pub. Date: Aug. 5, 2021

(54) LED Display System and LED Display Control Device

(71) Applicant: Mitsubishi Electric Corporation, Tokyo (JP)

(72) Inventors: Yoshinori ASAMURA, Tokyo (JP); Hirokazu TAGUCHI, Tokyo (JP)

(73) Assignee: Mitsubishi Electric Corporation, Tokyo (JP)

(21) Appl. No.: 17/049,182

(22) PCT Filed: Jul. 5, 2018
(86) PCT No.: PCT/JP2018/025465

§ 371 Date: Oct. 20, 2020

(51) Int. Cl. G09G 3/32

(52) U.S. Cl. CPC G09G 3/32; G09F 9/33; G09G 2310/0272; G09G 2320/0233

(57) ABSTRACT

The LED display system includes LED displays arranged in a matrix and a control device to control the LED displays. Each LED display includes a first display part including first LEDs provided on a display surface for displaying video, a second display part including at least one second LED provided on the other surface, a luminance measurement part to measure the luminance of the second LED, a first driving part to drive each first LED, and a second driving part to drive the second LED. The control device computes a luminance drop characteristic for each of the driving conditions on the basis of the luminance of the second LED, and corrects a luminance of the video on the basis of one luminance drop characteristic and the accumulative lighting-up time. The control device performs control to cause the LED displays to display the video after the correction of the luminance.

### TECHNICAL FIELD

The present invention relates to an LED display system, an LED display, and an LED display control device.

### BACKGROUND ART

With the development of LED technology and reductions in the cost of LEDs, LED displays that display images via a plurality of light emitting devices (LEDs) have been used in many applications such as outdoor and indoor advertising display.

Specifically, LED displays have conventionally been used primarily in display of nature description images and animation moving images. However in recent years, LED displays have also been used in indoor applications such as conference rooms and monitoring purposes because, with reduced pixel pitches, image quality can be maintained even at a short distance of visibility. Among these LED displays, those that are used for monitoring purposes often display personal computer images that are close to still images.

Methods for adjusting the brightness of images displayed on LED displays include a method that involves adjusting duty ratios of LEDs that are under pulse width modulation (PWM) control, and a method that involves adjusting current values for driving LEDs. In the case where the duty ratios are adjusted to lower the brightness of an image, the quality of tone that can be displayed may deteriorate. Therefore, in order to maintain good image quality, it is preferable that, even in the case of displaying a low-tone image, displays adjust the brightness of the image by changing current values for driving LEDs.

Luminances of LEDs decrease with increasing accumulative lighting-up times of the LEDs. Depending on the content of an image to be displayed, a difference occurs in the accumulative lighting-up time of each LED, and accordingly a difference occurs in the luminance drop rate of each LED. As a result, as the accumulative lighting-up times increase, variations in luminance and chromaticity occur among pixels.

In order to reduce such variations in luminance and chromaticity, a technique has been proposed that involves using a reference LED to correct the luminance of an LED display surface, i.e., a surface on which desired images are displayed for observers (e.g., Patent Document 1). The reference LED is mounted on one of the two surfaces of a circuit board on the side opposite to a surface on which a plurality of LEDs are mounted to constitute an LED display surface.

### PRIOR ART DOCUMENT

### Patent Document

Patent Document 1: Japanese Patent Application Laid-Open No. 2014-102484

### SUMMARY

### Problem to be Solved by the Invention

The aforementioned reference LED is driven in the same manner as the LEDs mounted on the display surface side and deteriorates in the same manner as the LEDs on the display surface side. An LED display can detect the luminance of the reference LED with an optical sensor to measure the luminance drop rate of the reference LED and can correct the luminances of the LEDs on the display surface side on the basis of the luminance drop rate. This technique allows the LED display to correct variations in the luminance and chromaticity of the LED display surface caused by differences in the lighting-up times of the LEDs.

However, the following problem arises in the case where fixed light emission control such that a single reference LED is driven with a fixed current value is performed with respect to a single circuit board on which the plurality of LEDs forming a display surface are mounted. In the case where the driving current value for the LEDs on the display surface side is changed in order to adjust the brightness of the LEDs in the midst of operation of an LED display, drops in the luminances of the LEDs progress in different ways depending on the LED lighting method or the driving current value. Therefore, it is difficult to correct, on the basis of the luminance drop rate of the single reference LED, variations in the luminance and chromaticity of the LED display surface that are caused not only by a difference in the accumulative lighting-up times of the LEDs but also by a change in the driving current value.

The present invention has been made in light of the problems as described above, and it is an object of the present invention to provide an LED display system that reduces variations in the luminance and chromaticity of a display part.

### Means to Solve the Problem

An LED display system according to the present invention includes a plurality of LED displays arranged in a matrix and each having a display surface, the display surfaces of the plurality of LED displays being arranged to form one screen, and an LED display control device to perform control to cause the plurality of LED displays to display video on the one screen by distributing a video signal to the plurality of LED displays. Each of the plurality of LED displays includes a first display part including a plurality of first LEDs provided on the display surface, a second display part including at least one second LED provided on a surface different from the display surface, a luminance measurement part to measure a luminance of the at least one second LED, a first driving part to drive each of the plurality of first LEDs under a first driving condition based on the video signal, and a second driving part to drive the at least one second LED under one second driving condition among a plurality of second driving conditions determined in advance. The LED display control device includes a luminance-drop-characteristics arithmetic part configured to acquire a plurality of luminance drop characteristics by acquiring a result of measuring the luminance of the at least one second LED, each driven under different second driving conditions, from the plurality of LED displays and computing a luminance drop characteristic of the at least one second LED with respect to an accumulative lighting-up time for each of the plurality of second driving conditions determined in advance, and a luminance correction part configured to correct a luminance of the video included in the video signal for each of the plurality of first LEDs on the basis of one luminance drop characteristic among the plurality of luminance drop characteristics and an accumulative lighting-up time of each of the plurality of first LEDs. The LED display control device performs control to cause the plurality of LED displays to display the video after the correction of the luminance on the one screen by distributing the video signal after the correction of the luminance to the plurality of LED displays.

### Effects of the Invention

According to the present invention, it is possible to provide an LED display system that reduces variations in the luminance and chromaticity of the display part.

The objects, features, aspects and advantages of the present invention will become more apparent from the following detailed description when taken into conjunction with the accompanying drawings.

### BRIEF DESCRIPTION OF DRAWINGS

FIG. 1 is a diagram illustrating a configuration of an LED display system according to Embodiment 1;

FIG. 2 is a block diagram illustrating an internal configuration of one LED display according to Embodiment 1;

FIG. 3 is a diagram illustrating a configuration of a first display part according to Embodiment 1;

FIG. 4 is a diagram illustrating a configuration of a second display part according to Embodiment 1;

FIG. 5 is a block diagram illustrating an internal configuration of an LED display control device according to Embodiment 1;

FIG. 6 is a diagram showing one example of duty ratios of pulse widths for PWM control according to Embodiment 1;

FIG. 7 is a diagram showing one example of luminance drop characteristics for each duty ratio according to Embodiment 1;

FIG. 8 is a diagram illustrating one example of luminance drop characteristics in a normal luminance mode and a high luminance mode according to Embodiment 2;

FIG. 9 is a diagram showing one example of luminance drop characteristics in cases where the luminance mode is switched according to Embodiment 2;

FIG. 10 is a block diagram illustrating an internal configuration of one LED display according to Embodiment 3;

FIG. 11 is a block diagram illustrating an internal configuration of an LED display control device according to Embodiment 3;

FIG. 12 is a diagram showing one example of a processing circuit according to Embodiment 3; and

FIG. 13 is a diagram showing another example of the processing circuit according to Embodiment 3.

### DESCRIPTION OF EMBODIMENTS

### Embodiment 1

An LED display system according to Embodiment 1 will be described.

Configuration of LED Display System

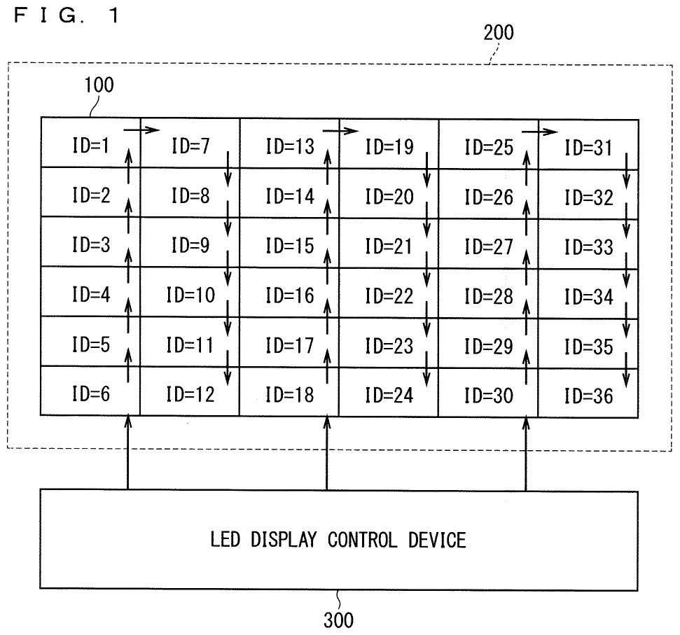

FIG. 1 is a diagram illustrating a configuration of the LED display system according to Embodiment 1. The LED display system includes a plurality of LED displays 100 and an LED display control device 300.

The LED displays 100 are arranged in a matrix and constitute a total LED display 200. The total LED display 200 is an array body in which the LED displays 100 are arranged. The total LED display 200 has one screen in which display surfaces of the LED displays 100 are each arranged. In Embodiment 1, the total LED display 200 has a configuration in which six LED displays 100 are arranged in a horizontal direction and six LED displays 100 are arranged in a vertical direction. The LED displays 100 are each assigned an ID number (ID=1 to 36).

Each LED display 100 has 320 horizontal pixels by 180 vertical pixels. Thus, the total LED display 200 has one Full HD screen of 1920 pixels by 1080 pixels. The LED display system is capable of displaying video including characters, graphics, and images on the one screen of the total LED display 200.

The LED display control device 300 performs control to cause the LED displays 100 to display video on the one screen of the total LED display 200 by distributing a video signal to each LED display 100 and communicating a control signal to each LED display 100. In Embodiment 1, the total LED display 200 is divided into three groups. Each one group includes 12 LED displays 100. The 12 LED displays 100 in each group are daisy-chained to the LED display control device 300. Daisy chaining allows the LED display control device 300 to efficiently distribute a video signal and communicate a control signal. The LED display control device 300 is, for example, an LED control unit.

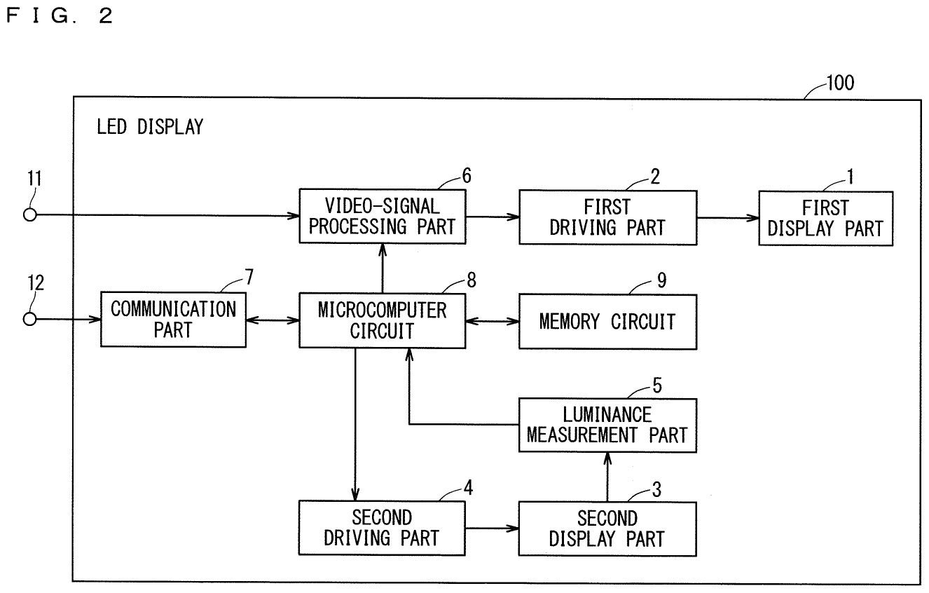

FIG. 2 is a block diagram illustrating an internal configuration of one LED display 100 according to Embodiment 1. The LED display 100 includes a first display part 1, a second display part 3, a video-signal processing part 6, a first driving part 2, a communication part 7, a second driving part 4, a luminance measurement part 5, a microcomputer circuit 8, and a memory circuit 9. As a configuration relating to the LED display 100, a video input terminal 11 and a control signal terminal 12 are also illustrated in FIG. 2.

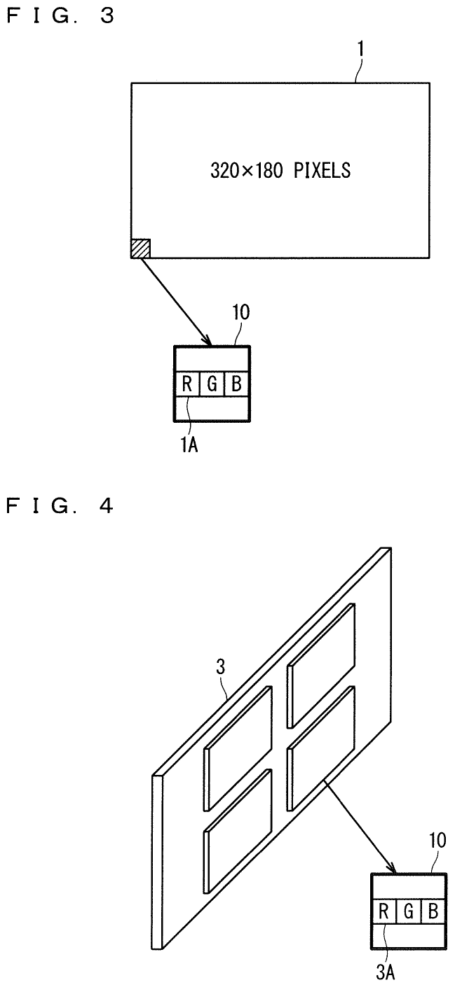

The first display part 1 includes a plurality of first LEDs provided on a display surface. The first display part 1 also includes a plurality of pixels arranged in a matrix. The first display part 1 constitutes part of the one screen of the total LED display 200. FIG. 3 is a diagram illustrating a configuration of the first display part 1 according to Embodiment 1. The first display part 1 has a configuration in which 320 pixels 10 are arranged in the horizontal direction and 180 pixels 10 are arranged in the vertical direction. In Embodiment 1, each one pixel 10 is configured of a set of three first LEDs 1A that respectively emit red (R), green (G), blue (B) light.

The second display part 3 includes at least one second LED provided on a surface different from the display surface. The surface different from the display surface is, for example, a back surface on the side opposite to the display surface. FIG. 4 is a diagram illustrating a configuration of the second display part 3 according to Embodiment 1. The second display part 3 has a configuration in which two pixels 10 are arranged in the horizontal direction and two pixels 10 are arranged in the vertical direction. Each one pixel 10 of the second display part 3 includes a set of three second LEDs 3A that respectively emit red (R), green (G), blue (B) light. The second display part 3 gives a display for allowing the LED display system to predict the transition of the luminance of the first display part 1.

In Embodiment 1, if each second LED 3A of the second display part 3 is driven for the same amount of time under the same driving condition (e.g., the same driving current value) as each first LED 1A of the first display part 1, each second LED 3A shows a similar transition of luminance to that of each first LED 1A. The transition of luminance involves, for example, a luminance maintenance factor that indicates the ratio of the current luminance to the initial luminance of 100%, or a luminance drop rate (=100%−luminance maintenance factor) that is in the inverse relationship with the luminance maintenance factor. For example, the luminance drop rate of each second LED 3A is the same as the luminance drop rate of each first LED 1A, or similar to the extent that both can be regarded as being identical. Each first LED 1A and each second LED 3A are, for example, LEDs coming from the same manufacturing lot. LEDs from the same manufacturing lot have similar characteristics including luminance, wavelength and so on. In the case where both are driven with the same driving current, their luminance drop rates are identical.

The video input terminal 11 receives a video signal from the daisy-chained upstream LED display 100 or the LED display control device 300. The video signal is a signal that includes video data about video to be displayed on the total LED display 200.

The video-signal processing part 6 performs processing such as selection processing on the video signal received at the video input terminal 11. In the selection processing, the video-signal processing part 6 selects a video region to be displayed on the LED display 100 including its video-signal processing part 6 from the video included in the video signal.

The first driving part 2 drives each first LED 1A under a first driving condition based on the video signal. Here, the first driving condition includes a condition concerning duty ratios for PWM control of each first LED 1A. The first driving part 2 performs PWM control to drive each first LED 1A for each color on the basis of the signal processed by the video-signal processing part 6. The first display part 1 displays video of the video region selected by the video-signal processing part 6.

The control signal terminal 12 receives a control signal from the daisy-chained upstream LED display 100 or the LED display control device 300. The control signal is, for example, a signal that includes control data such as a luminance correction coefficient.

The communication part 7 communicates with the LED display control device 300 via the control signal terminal 12, for example. The communication part 7 outputs a control signal received from the LED display control device 300 to the microcomputer circuit 8. The communication part 7 also transmits a control signal input from the microcomputer circuit 8 to the LED display control device 300.

The second driving part 4 drives each second LED 3A under one of a plurality of second driving conditions determined in advance. Here, the second driving condition includes a condition concerning duty ratios for PWM control of each second LED 3A. The second driving part 4 performs PWM control to drive each second LED 3A at one of three duty ratios determined in advance. The second driving part 4 drives the second LEDs 3A at different second driving conditions for the respective three groups into which the LED displays 100 are divided. For example, the second LEDs 3A of the LED displays 100 with ID numbers 1 to 12 are driven at a duty ratio of 100%. The second LEDs 3A of the LED displays 100 with ID numbers 13 to 24 are driven at a duty ratio of 80%. The second LEDs 3A of the LED displays 100 with ID numbers 25 to 36 are driven at a duty ratio of 60%. The second driving part 4 also drives the second LED 3A all the time under the single corresponding second driving condition.

The luminance measurement part 5 measures the luminance of at least one second LED 3A. The luminance measurement part 5 includes, for example, light receiving devices. The result of measuring luminance is output to the microcomputer circuit 8.

The microcomputer circuit 8 performs overall control of the constituent elements of the LED display 100. In Embodiment 1, the microcomputer circuit 8 performs control of the video-signal processing part 6, control of the driving parts, control of the communication part 7, control of the second driving part 4, control of the luminance measurement part 5, and reading and writing control of the memory circuit 9.

The memory circuit 9 stores various parameters. Various parameters include, for example, individual luminance correction coefficients that are coefficients for correcting the luminance of the respective first LEDs 1A, corrected luminances that are the luminances of the respective first LEDs 1A corrected by the individual luminance correction coefficients, and other necessary set values and adjusted values. The individual luminance correction coefficient is a luminance correction coefficient obtained individually for each LED display 100 and for correcting variations in the luminance and chromaticity of each LED display 100. The memory circuit 9 stores initial values of the individual luminance correction coefficients and initial values of the corrected luminances at the time of shipment from the factory.

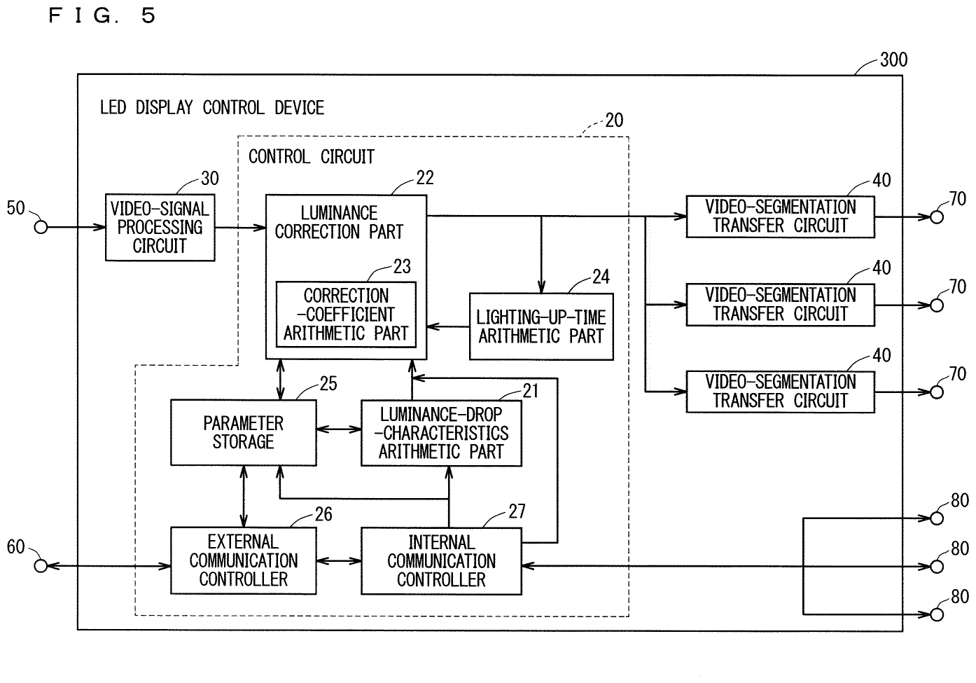

FIG. 5 is a block diagram illustrating an internal configuration of the LED display control device 300 according to Embodiment 1. The LED display control device 300 includes a video-signal processing circuit 30, a control circuit 20, and video-segmentation transfer circuits 40. As a configuration relating to the LED display control device 300, a video-signal input terminal 50, an external signal terminal 60, video output terminals 70, and control signal terminals 80 are also illustrated in FIG. 5.

The video-signal input terminal 50 receives a video signal from the outside.

The video-signal processing circuit 30 performs processing such as gamma correction on the video signal received at the video-signal input terminal 50.

The external signal terminal 60 receives a control signal for controlling the LED display control device 300 and each LED display 100 from an external personal computer (PC) or other devices.

The control circuit 20 is connected to the control signal terminal 12 (FIG. 2) of each of front-end LED displays 100 (ID=6, 18, 30) in the three groups via the three control signal terminals 80. The control circuit 20 transmits control signals to a plurality of LED displays 100 and receives control signals from a plurality of LED displays 100. In this way, the control circuit 20 controls the total LED display 200. The control circuit 20 also controls correction of the video signal on the basis of a control signal received at the external signal terminal 60 and a control signal transmitted from the communication part 7 of each of the LED displays 100.

The video-segmentation transfer circuits 40 are respectively connected to the video input terminals 11 (FIG. 2) of the front-end LED displays 100 (with ID numbers 6, 18, and 30) in the three groups via the video output terminals 70. The video-segmentation transfer circuits 40 divide the video signal corrected by the control circuit 20 into three video signals, each corresponding to video to be displayed on the LED displays 100 in each group. The video-segmentation transfer circuits 40 transmit the three video signals respectively to the LED displays 100 in the three groups.

The control circuit 20 includes a lighting-up-time arithmetic part 24, a parameter storage 25, a luminance-drop-characteristics arithmetic part 21, a luminance correction part 22, an external communication controller 26, and an internal communication controller 27. The luminance correction part 22 includes a correction-coefficient arithmetic part 23.

The lighting-up-time arithmetic part 24 computes and stores the accumulative lighting-up time and an average duty ratio of each first LED 1A in 1920 pixels by 1080 pixels of the total LED display 200 at regular time intervals.

The internal communication controller 27 stores parameters included in the control signal received at the control signal terminals 80 in the parameter storage 25 or outputs these parameters to the external communication controller 26, the luminance correction part 22, or the luminance-drop-characteristics arithmetic part 21. The internal communication controller 27 also transmits parameters stored in the parameter storage 25 to a plurality of LED displays 100 via the control signal terminals 80. Alternatively, the internal communication controller 27 transmits parameters or the like input from the external communication controller 26, the luminance correction part 22, or the luminance-drop-characteristics arithmetic part 21 to a plurality of LED displays 100 via the control signal terminals 80.

The luminance-drop-characteristics arithmetic part 21 acquires the results of measuring the luminances of the second LEDs 3A that are driven under the respective different second driving conditions from a plurality of LED displays 100. The luminance-drop-characteristics arithmetic part 21 computes a luminance drop characteristic with respect to the accumulative lighting-up time of the second LEDs 3A for each of the second driving conditions determined in advance, so as to acquire a plurality of luminance drop characteristics.

The luminance correction part 22 corrects the luminance of the video signal processed by the video-signal processing circuit 30. The luminance correction part 22 corrects the luminance of the video signal for each of a plurality of first LEDs 1A on the basis of one of the luminance drop characteristics and the accumulative lighting-up time of each first LED 1A. For example, the luminance correction part 22 selects one luminance drop characteristic on the basis of the first driving condition. That is, the luminance correction part 22 selects a luminance drop characteristic obtained from driving at the duty ratio close to the average duty ratio of the first LEDs 1A.

The correction-coefficient arithmetic part 23 calculates a first luminance correction coefficient for uniformly correcting the luminance of the one screen of the total LED display 200. At this time, the correction-coefficient arithmetic part 23 calculates the first luminance correction coefficient on the basis of the individual luminance correction coefficients of each LED display 100. For example, the correction-coefficient arithmetic part 23 calculates the first luminance correction coefficient so as to make uniform the luminance of the one screen, on the basis of the individual luminance correction coefficients and the corrected luminances acquired from the plurality of LED displays 100. The correction-coefficient arithmetic part 23 further calculates a second luminance correction coefficient by correcting the first luminance correction coefficient on the basis of the accumulative lighting-up time of each first LED 1A in one luminance drop characteristic. The luminance correction part 22 corrects the luminance of the video included in the video signal for each of a plurality of first LEDs 1A by using the second luminance correction coefficient.

The external communication controller 26 stores parameters included in the control signal received at an external control terminal in the parameter storage 25 and outputs these parameters to the internal communication controller 27. The external communication controller 26 also transmits parameters stored in the parameter storage 25 or parameters input from the internal communication controller 27 to the outside via the external control terminal.

Operations of LED Display System

Operations of the LED display system and a luminance correction method according to Embodiment 1 will be described.

As described previously, the memory circuit 9 stores the initial values of the individual luminance correction coefficients and the corrected luminances at the time of shipment from the factory. A method for obtaining the individual luminance correction coefficients and the corrected luminances will be described below. The individual luminance correction coefficients and the corrected luminances are obtained by, for example, measuring the luminances of the first LEDs 1A each corresponding to R, G and B of each pixel 10.

Expression (1) below gives individual luminance correction coefficients Cr(uh, uv), Cg(uh, uv), and Cb(uh, uv).

Cr(uh,uv)=Yr_min/Yr(uh,uv)

Cg(uh,uv)=Yg_min/Yg(uh,uv)

Cb(uh,uv)=Yb_min/Yb(uh,uv) Expression (1)

Here, Yr(uh, uv), Yg(uh, uv), and Yb(uh, uv) are respectively the R luminance, G luminance, and B luminance of the first LEDs 1A before correction, uh (=0 to 319) is the horizontal pixel position in one LED display 100, and uv (=0 to 179) is the vertical pixel position. In the process of calculating the individual luminance correction coefficients, Yr(uh, uv), Yg(uh, uv), and Yb(uh, uv) are, for example, the R luminance, the G luminance, and the B luminance in the case where all of the first LEDs 1A in one LED display 100 light up at maximum tone. Also, Yr_min, Yg_min, and Yb_min correspond respectively to minimum luminances of Yr(uh, uv), Yg(uh, uv), and Yb(uh, uv).

The R, G, and B luminances (corrected luminances) of the first LEDs 1A corrected using the individual luminance correction coefficients become equal to Yr_min, Yg_min, and Yb_min, respectively. That is, the luminance of the display surface of each LED display 100 is made uniform by reducing the luminances of first LEDs 1A whose luminances are higher than the minimum luminances.

The memory circuit 9 stores the individual luminance correction coefficients Cr(uh, uv), Cg(uh, uv), and Cb(uh, uv) and the corrected luminances Yr_min, Yg_min, and Yb_min. The communication part 7 transmits the individual luminance correction coefficients and the corrected luminances stored in the memory circuit 9 to the LED display control device 300 under the control of the microcomputer circuit 8.

Next, an operation of correcting the luminance of the LED display system at the time of initial setting will be described.

The LED display control device 300 associates the ID number of each LED display 100 with the coordinate position of one pixel 10 in the full screen of 1920 pixels by 1080 pixels. Expression (2) below indicates the coordinates IDn(h0, v0) of the pixel 10 located in the upper left part of each LED display 100, where n is the ID number. For example, ID1(h0, v0) indicates the coordinates of the pixel 10 located in the upper left part of the LED display with ID number 1.

$$Expression ( 2 ) \\ IDn ( h 0 , v 0 ) = ( \begin{matrix}ID 1 ( 0 , 0 ) , ID 2 ( 0 , vsize ) , … ID 6 ( 0 , vsize \times 5 ) \\ ID 7 ( hsize , 0 ) , ID 8 ( hsize , vsize ) , … ID 12 ( hsize , vsize \times 5 ) \\ ID 13 ( hsize \times 2 , 0 ) , ID 14 ( hsize \times 2 , vsize ) , … \\ ID 18 ( hsize \times 2 , vsize \times 5 ) \\ \begin{matrix}ID 19 ( hsize \times 3 , 0 ) , ID 20 ( hsize \times 3 , vsize ) , … \\ ID 24 ( hsize \times 3 , vsize \times 5 )\end{matrix} \\ \begin{matrix}ID 25 ( hsize \times 4 , 0 ) , ID 26 ( hsize \times 4 , vsize ) , … \\ ID 30 ( hsize \times 4 , vsize \times 5 )\end{matrix} \\ \begin{matrix}ID 31 ( hsize \times 5 , 0 ) , ID 32 ( hsize \times 5 , vsize ) , … \\ ID 36 ( hsize \times 5 , vsize \times 5 )\end{matrix}\end{matrix} ) \qquad$$

Here, hsize (=320) is the number of horizontal pixels in each LED display 100, and vsize (=180) is the number of vertical pixels.

Next, the LED display control device 300 acquires the individual luminance correction coefficients and the corrected luminances from each LED display 100. The correction-coefficient arithmetic part 23 obtains first luminance correction coefficients for the full screen consisting of 1920 pixels by 1080 pixels on the basis of the individual luminance correction coefficients and the corrected luminances. To be more specific, the correction-coefficient arithmetic part 23 obtains the first luminance correction coefficients by multiplying the individual luminance correction coefficients by correction coefficients obtained from the corrected luminances.

First luminance correction coefficients Cr0(h, v), Cg0(h, v), and Cb0(h, v) for each LED display 100 are given by Expressions (3) to (9) below. Expressions (3) to (9) are expressions for obtaining the first luminance correction coefficients for LED displays 100 that correspond to representative IDs. The first luminance correction coefficients for the other LED displays 100 with IDs not given by the following expressions are also obtained in the same manner

Here, h (=0 to 1919) is the pixel position in the horizontal direction, and v (=0 to 1079) is the pixel position in the vertical direction. IDn_Cr(uh, uv), IDn_Cg(uh, uv), and IDn_Cb(uh, uv) are the individual luminance correction coefficients of each LED display 100 received by the LED display control device 300. IDnYr_min, IDnYg_min, and IDnYb_min are the corrected luminances of each LED display 100 received by the LED display control device 300. Unit_Yr_min, Unit_Yg_min, and Unit_Yb_min are minimum values of the corrected luminances of the total LED display 200.

Expression (3) indicates the first luminance correction coefficients for the first LEDs 1A (h=0 to 319, v=0 to 179) of the LED display 100 with ID number 1.

Cr0(h,v)=ID1_Cr(h,v)×Unit_Yr_min/ID1_Yr_min

Cg0(h,v)=ID1_Cg(h,v)×Unit_Yg_min/ID1_Yg_min

Cb0(h,v)=ID1_Cb(h,v)×Unit_Yb_min/ID1_Yb_min Expression (3)

Expression (4) indicates the first luminance correction coefficients for the first LEDs 1A (h=0 to 319, v=180 to 359) of the LED display 100 with ID number 2.

Cr0(h,v)=ID2_Cr(h,v−vsize)×Unit_Yr_min/ID2_Yr_min

Cg0(h,v)=ID2_Cg(h,v−vsize)×Unit_Yg_min/ID2_Yg_min

Cb0(h,v)=ID2_Cb(h,v−vsize)×Unit_Yb_min/ID2_Yb_min Expression (4)

Expression (5) indicates the first luminance correction coefficients for the first LEDs 1A (h=0 to 319, v=900 to 1079) of the LED display 100 with ID number 6.

Cr0(h,v)=ID6_Cr(h,v−vsize×5)×Unit_Yr_min/ID6_Yr_min

Cg0(h,v)=ID6_Cg(h,v−vsize×5)×Unit_Yg_min/ID6_Yg_min

Cb0(h,v)=ID6_Cb(h,v−vsize×5)×Unit_Yb_min/ID6_Yb_min Expression (5)

Expression (6) indicates the first luminance correction coefficients for the first LEDs 1A (h=320 to 639, v=0 to 179) of the LED display 100 with ID number 7.

Cr0(h,v)=ID7_Cr(h−hsize,v)×Unit_Yr_min/ID7_Yr_min

Cg0(h,v)=ID7_Cg(h−hsize,v)×Unit_Yg_min/ID7_Yg_min

Cb0(h,v)=ID7_Cb(h−hsize,v)×Unit_Yb_min/ID7_Yb_min Expression (6)

Expression (7) indicates the first luminance correction coefficients for the first LEDs 1A (h=320 to 639, v=180 to 359) of the LED display 100 with ID number 8.

Cr0(h,v)=ID8_Cr(h−hsize,v−vsize)×Unit_Yr_min/ID8_Yr_min

Cg0(h,v)=ID8_Cg(h−hsize,v−vsize)×Unit_Yg_min/ID8_Yg_min

Cb0(h,v)=ID8_Cb(h−hsize,v−vzize)×Unit_Yb_min/ID8_Yb_min Expression (7)

Expression (8) indicates the first luminance correction coefficients for the first LEDs 1A (h=320 to 639, v=900 to 1079) of the LED display 100 with ID number 12.

Cr0(h,v)=ID12_Cr(h−hsize,v−vsize×5)×Unit_Yr_min/ID12_Yr_min

Cg0(h,v)=ID12_Cg(h−hsize,v−vsize×5)×Unit_Yg_min/ID12_Yg_min

Cb0(h,v)=ID12_Cb(h−hsize,v−vzize×5)×Unit_Yb_min/ID12_Yb_min Expression (8)

Expression (9) indicates the first luminance correction coefficients for the first LEDs 1A (h=1600 to 1919, v=180 to 359) of the LED display 100 with ID number 36.

Cr0(h,v)=ID36_Cr(h−hsize×5,v−vsize×5)×Unit_Yr_min/ID36_Yr_min

Cg0(h,v)=ID36_Cg(h−hsize×5,v−vsize×5)×Unit_Yg_min/ID36_Yg_min

Cb0(h,v)=ID36_Cb(h−hsize×5,v−vzize×5)×Unit_Yb_min/ID36_Yb_min Expression (9)

In Expressions (3) to (9), Unit_Yr_min/IDn_Yr_min, Unit_Yg_min/IDn_Yg_min, and Unit_Yb_min/IDn_Yb_min correspond to the aforementioned correction coefficients. As expressed in the above expressions, the correction-coefficient arithmetic part 23 obtains the first luminance correction coefficients by multiplying the individual luminance correction coefficients by the correction coefficients. The parameter storage 25 stores these calculated first luminance correction coefficients.

The luminance of the display surface of each LED display 100 can already be made uniform by using the individual luminance correction coefficients. The luminance correction part 22 can further make uniform the luminance of the one screen of the total LED display 200 by using the first luminance correction coefficients. As expressed in each of the above expressions, the luminance correction part 22 can set a minimum luminance value in the one screen of the total LED display 200 to a reference value of the luminance of the total LED display 200. In this way, by using the first luminance correction coefficients, the LED display control device 300 can reduce variations in luminance and chromaticity among the plurality of LED displays 100.

In order to further reduce variations in luminance, the luminance correction part 22 corrects the luminance of each first LED 1A by using second luminance correction coefficients obtained by correcting the first luminance correction coefficients. The second luminance correction coefficients are luminance correction coefficients obtained by correcting the first luminance correction coefficients on the basis of the accumulative lighting-up time of the total LED display 200 and the results of measuring the luminance of the second display part 3 of each LED display 100.

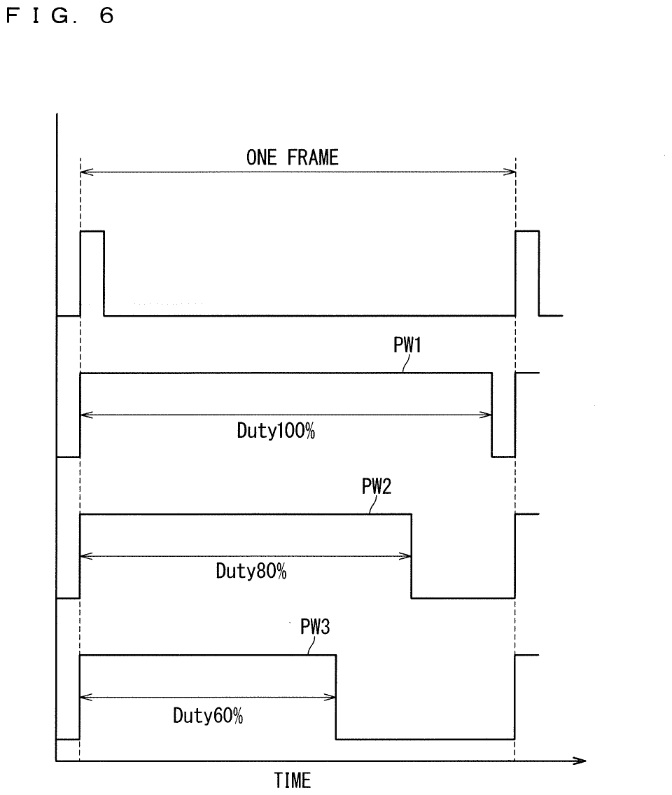

The first driving part 2 of each LED display 100 drives a plurality of first LEDs 1A by a PWM method on the basis of a video data value. Thereby, the luminances of the first LEDs 1A are controlled. FIG. 6 is a diagram showing one example of duty ratios of pulse widths under PWM control. FIG. 6 shows a fundamental period, a waveform PW1 at a duty ratio of 100%, a waveform PW2 at a duty ratio of 80%, and a waveform PW3 at a duty ratio of 60% from the top in the stated order. Here, the fundamental period of PWM is less than or equal to one frame period of a video signal.

The first driving part 2 changes duty ratios on the basis of luminance information included in the video signal, i.e., changes the lighting-up period and the lights-out period of each first LED 1A per unit time. By changing the duty ratio for each color, the first driving part 2 can adjust luminance for each color that can be recognized by human eye.

Similarly, it is also possible to correct uniformity in luminance by changing the duty ratios of pulse widths. In this case, in accordance with the correction of luminance values by the luminance correction part 22, the first driving part 2 drives each first LED 1A at a duty ratio corresponding to the corrected luminance for the first LED 1A. That is, the lighting-up period and the lights-out period per unit time are changed. As a result, each first LED 1A lights up with the corrected luminance

The LED display system performs the display operation, i.e., driving, of the first display part 1 and the display operation, i.e., driving, of the second display part 3 in parallel. In one LED display 100, each first LED 1A and each second LED 3A light up in similar environments, so that their luminance drop rates approach each other.

On the other hand, each first LED 1A and each second LED 3A have different accumulative lighting-up times. Since the lighting of the plurality of first LEDs 1A is controlled based on an image to be displayed on the first display part 1, the first LEDs 1A do not light up for a longer amount of time. On the other hand, the lighting of each second LED 3A is not based on the image to be displayed on the first display part 1, but is controlled all the time at one of a plurality of duty ratios determined in advance. That is, each second LED 3A lights up all the time at a fixed duty ratio. Since the lighting of a plurality of first LEDs 1A is controlled based on the luminance of an image, each pixel 10 has a different accumulative lighting-up time. That is, a difference in accumulative lighting-up time occurs among the first LEDs 1A.

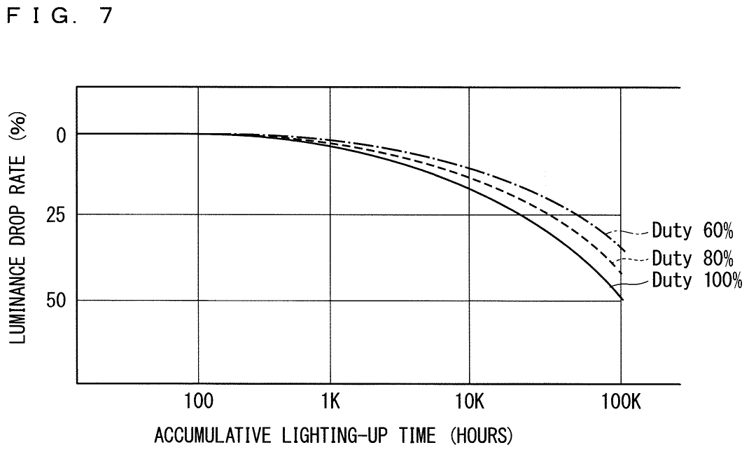

FIG. 7 is a diagram showing one example of luminance drop characteristics for each duty ratio according to Embodiment 1. Here, the luminance drop characteristics refer to the relationship between the accumulative lighting-up time and the luminance drop rate. FIG. 7 shows luminance drop rates in cases where the second LEDs 3A light up at duty ratios of 100%, 80%, and 60%. Note that a logarithmic scale is adopted for the accumulative lighting-up time in FIG. 7. As the duty ratio increases, the luminances of the second LEDs 3A increase, and heat load accompanying a temperature rise caused by light emission becomes greater. As a result, the luminance drop rate of the second

LEDs 3A increases. Meanwhile, as the duty ratio decreases, a temperature rise caused by the light emission of the second LEDs 3A becomes smaller. Since a drop in luminance accompanying the temperature rise can be ignored, there are smaller variations in luminance drop rate that depends on a change in duty ratio.

As described previously, the second LEDs 3A and the first LEDs 1A have similar luminance drop characteristics. Thus, the luminances of the first LEDs 1A decrease with the accumulative lighting-up times in the same manner as indicated by the luminance drop characteristics illustrated in FIG. 7. The LED display system according to Embodiment 1 corrects the luminance of each first LED 1A on the basis of the accumulative lighting-up time of the first LED 1A. This correction operation, i.e., a luminance correction operation performed after luminance correction at the time of initial setting, will be described in detail hereinafter.

In Embodiment 1, the LED display system controls driving of the second LEDs 3A as follows. Each second LED 3A of the LED displays 100 with ID numbers 1 to 12 is driven at a duty ratio of 100%, each second LED 3A of the LED displays 100 with ID numbers 13 to 24 is driven at a duty ratio of 80%, and each second LED 3A of the LED displays 100 with ID numbers 25 to 36 is driven at a duty ratio of 60%.

The result of measuring the luminance of the second LEDs 3A by the luminance measurement part 5 is input to the microcomputer circuit 8. The microcomputer circuit 8 calculates the luminance drop rate of the second LEDs 3A from the initial value of the result of measuring the luminance of the second LEDs 3A and the current luminance measurement result. In each of the LED displays 100, the luminance drop rates of the second LEDs 3A are calculated.

The luminance-drop-characteristics arithmetic part 21 acquires the luminance drop rate of the second LEDs 3A from each LED display 100 via the communication part 7. That is, the luminance-drop-characteristics arithmetic part 21 acquires a plurality of luminance drop rates that correspond to the second LEDs 3A driven at the respective different duty ratios. The luminance-drop-characteristics arithmetic part 21 generates luminance-drop-rate tables on the basis of the current-carrying time and luminance drop rate of each LED display 100. At this time, the luminance-drop-characteristics arithmetic part 21 generates the luminance-drop-rate tables for each duty ratio. The parameter storage 25 stores the generated luminance-drop-rate tables. The luminance-drop-characteristics arithmetic part 21 updates the luminance-drop-rate tables at any time over time, and the parameter storage 25 stores the updated luminance-drop-rate tables. For example, the luminance-drop-characteristics arithmetic part 21 hourly receives the luminance drop rate from each LED display 100 and updates the luminance-drop-rate tables. In Embodiment 1, 12 LED displays 100 are provided for one duty ratio. The luminance-drop-characteristics arithmetic part 21 calculates an average value of 12 luminance drop rates obtained from the 12 LED displays 100 and generates a luminance-drop-rate table for each duty ratio.

The lighting-up-time arithmetic part 24 stores, at a predetermined time interval, the average duty ratios and accumulative lighting-up times (Tr, Tg, Tb) for each color of all the first LEDs 1A in the total LED display 200, and the accumulative current-carrying times of the LED displays 100. The lighting-up-time arithmetic part 24 obtains the average duty ratios and the accumulative lighting-up times on the basis of the output of the luminance correction part 22. For example, if the unit current-carrying time is one hour and the duty ratio during the unit current-carrying time is 10% (i.e., the luminance level is 10%), the lighting-up-time arithmetic part 24 hourly adds a lighting-up time of 0.1 hours to the accumulative lighting-up time. The lighting-up-time arithmetic part 24 also calculates the average duty ratios by dividing the accumulative lighting-up time of each first LED 1A by the accumulative current-carrying times of the LED displays 100.

The correction-coefficient arithmetic part 23 obtains luminance maintenance factors of the total LED display 200 on the basis of the accumulative lighting-up times obtained by the lighting-up-time arithmetic part 24 and the luminance-drop-rate tables stored in the parameter storage 25. At this time, the correction-coefficient arithmetic part 23 obtains the luminance maintenance factors for each color. The R luminance maintenance factor Pr(h, v) of each pixel 10 is obtained from Expressions (10) to (12) below. The G luminance maintenance factor Pg(h, v) of each pixel 10 is obtained from Expressions (13) to (15) below. The B luminance maintenance factor Pb(h, v) of each pixel 10 is obtained from Expressions (16) to (18) below.

Here, FPr1(t), FPg1(t), and FPb1(t) are respectively the R luminance maintenance factor, the G luminance maintenance factor, and the B luminance maintenance factor per accumulative lighting-up time at a duty ratio of 100% obtained from the result of measuring the luminance of each second display part 3. Similarly, FPr2(t), FPg2(t), and FPb2(t) are respectively the R luminance maintenance factor, the G luminance maintenance factor, and the B luminance maintenance factor at a duty ratio of 80%. Similarly, FPr3(t), FPg3(t), and FPb3(t) are respectively the R luminance maintenance factor, the G luminance maintenance factor, and the B luminance maintenance factor at a duty ratio of 60%.

Also, Tr(h, v), Tg(h, v), and Tb(h, v) are the accumulative lighting-up times of the first LEDs 1A for the respective colors. Dr(h, v), Dg(h, v), and Db(h, v) are the average duty ratios of the first LEDs 1A for the respective colors. Also, h is the horizontal pixel position (0 to 1919) and v is the vertical pixel position (0 to 1079).

Expression (10) gives the R luminance maintenance factor Pr(h, v) in the case where Dr(h, v)>80%.

Pr(h,v)=FPr1(Tr(h,v)) Expression (10)

Expression (11) gives the R luminance maintenance factor Pr(h, v) in the case where 80%≥Dr(h, v)>60%.

Pr(h,v)=FPr2(Tr(h,v)) Expression (11)

Expression (12) gives the R luminance maintenance factor Pr(h, v) in the case where 60%≥Dr(h, v).

Pr(h,v)=FPr3(Tr(h,v)) Expression (12)

Expression (13) gives the G luminance maintenance factor Pg(h, v) in the case where Dg(h, v)>80%.

Pg(h,v)=FPg1(Tg(h,v)) Expression (13)

Expression (14) gives the G luminance maintenance factor Pg(h, v) in the case where 80%≥Dg(h, v)>60%.

Pg(h,v)=FPg2(Tg(h,v)) Expression (14)

Expression (15) gives the G luminance maintenance factor Pg(h, v) in the case where 60%≥Dg(h, v).

Pg(h,v)=FPg3(Tg(h,v)) Expression (15)

Expression (16) gives the B luminance maintenance factor Pb(h, v) in the case where Db(h, v)>80%.

Pb(h,v)=FPb1(Tg(h,v)) Expression (16)

Expression (17) gives the B luminance maintenance factor Pb(h, v) in the case where 80%≥Db(h, v)>60%.

Pb(h,v)=FPb2(Tg(h,v)) Expression (17)

Expression (18) gives the B luminance maintenance factor Pb(h, v) in the case where 60%≥Db(h, v).

Pb(h,v)=FPb3(Tg(h,v)) Expression (18)

In order to correct initial variations in the luminances of a plurality of first LEDs 1A as described previously, the LED display system performs luminance correction by using the first luminance correction coefficients Cr0(h, v), Cg0(h, v), and Cb0(h, v). In this correction, relative values of actual luminances obtained in consideration of the luminance maintenance factors are given by Expression (19) below.

Qr(h,v)=Pr(h,v)/Cr0(h,v)

Qg(h,v)=Pg(h,v)/Cg0(h,v)

Qb(h,v)=Pb(h,v)/Cb0(h,v) Expression (19)

The correction-coefficient arithmetic part 23 obtains the relative values Qr(h, v), Qg(h, v), and Qb(h, v) of the actual luminance from Expression (19) above. Then, the correction-coefficient arithmetic part 23 obtains a minimum value Qrgb_min for the relative values of the actual luminance for all the R, G, and B pixels. The correction-coefficient arithmetic part 23 further obtains second luminance correction coefficients Cr1(h, v), Cg1(h, v), and Cb1(h, v) for correcting initial variations in the luminances of the first LEDs 1A and a drop in luminance caused by the accumulative lighting-up times by using Expression (20) below.

Cr1(h,=Qrgb_min/Qr(h,v)

Cg1(h,v)=Qrgb_min/Qg(h,v)

Cb1(h,v)=Qrgb_min/Qb(h,v) Expression (20)

In summary, the correction-coefficient arithmetic part 23 obtains luminance maintenance factors for the respective first LEDs 1A of one LED display 100 on the basis of the accumulative lighting-up time of the one LED display 100. At this time, the correction-coefficient arithmetic part 23 obtains the luminance maintenance factors for the respective colors of the first LED 1A. Similarly, the correction-coefficient arithmetic part 23 obtains luminance maintenance factors for the respective colors of a plurality of first LEDs 1A of the other LED displays 100 on the basis of the accumulative lighting-up times and average duty ratios (average luminances) of the other LED displays 100 and the luminance-drop-rate tables actually measured by each LED display 100.

Then, the correction-coefficient arithmetic part 23 changes the first luminance correction coefficients Cr0(h, v), Cg0(h, v), and Cb0(h, v) into the second luminance correction coefficients Cr1(h, v), Cg1(h, v), and Cb1(h, v) on the basis of the luminance maintenance factors of the one LED display 100 and the luminance maintenance factors of the other LED displays 100. The luminance correction part 22 corrects the luminance of video data included in the video signal on the basis of the second luminance correction coefficients.

The correction-coefficient arithmetic part 23 may perform the calculation of the second luminance correction coefficients Cr1(h, v), Cg1(h, v), and Cb1(h, v) and the luminance correction at a predetermined time interval (i.e., at an interval of 100 hours). As another alternative, the correction-coefficient arithmetic part 23 may perform this calculation and luminance correction at a time when a drop in luminance has occurred. The time when a drop in luminance has occurred refers to, for example, a case where Qrgb_min is reduced by 10% or more from Qrgb_min obtained by the previous correction. The duty ratios for driving the second LEDs 3A in each of the three groups are set to three types, i.e., 100%, 80%, and 60%, but the duty ratios are not limited to this example. The duty ratios may be two or more types of arbitrary duty ratios.

Summary of Embodiment 1

The lighting of each first LED 1A is not always driven at a duty ratio of 100%. In the case where all the second LEDs 3A in a plurality of LED displays 100 are driven at a duty ratio of 100%, the LED display system cannot accurately predict the luminance drop rates of the first display parts 1. This consequently increases an error in predicting a drop in luminance and deteriorates the accuracy of uniformity in the luminance of the screen after correction.

In contrast, the LED display system according to Embodiment 1 drives the second LEDs 3A at a plurality of duty ratios depending on a plurality of LED displays 100. The LED display system selects luminance-drop-rate tables corresponding to the most appropriate duty ratio on the basis of the average luminance of each pixel 10 then performs the corrections. This as a result reduces an error in predicting a drop in luminance and improves the accuracy of uniformity in luminance after correction.

The luminance correction part 22 is also capable of correcting luminances with reference to luminance-drop-rate tables stored in advance in the parameter storage 25 at the time of shipment from the factory. However, drops in the luminances of the first LEDs 1A vary depending on environmental temperatures or other factors. The presence of the second display part 3 for measuring luminances in each LED display 100 as in Embodiment 1 improves the accuracy of luminance correction.

Even in the case where the second LEDs 3A in one LED display 100 are driven at different duty ratios, it is possible to obtain the luminance-drop-rate tables for each duty ratio in the same manner. This, however, complicates a sequence of measuring the luminance of each second LED 3A. In Embodiment 1, the second LEDs 3A of one LED display 100 are driven at one duty ratio. Then, the LED display control device 300 collects the results of measuring the luminances of the second LEDs 3A driven at different duty ratios from a plurality of LED displays 100 and calculates a plurality of luminance drop characteristics. This simplifies the sequence of measuring the luminance of one LED display 100.

In summary, the LED display system according to Embodiment 1 includes the plurality of LED displays 100 arranged in a matrix and each having the display surface, the displays surfaces of the LED displays 100 being arranged to form one screen, and the LED display control device 300 to perform control to cause the LED displays 100 to display video on the one screen by distributing a video signal to each LED display 100. Each of the LED displays 100 includes the first display part 1 including the plurality of first LEDs 1A provided on the display surface, the second display part 3 including the at least one second LED 3A provided on the surface different from the display surface, the luminance measurement part 5 to measure the luminance of the at least one second LED 3A, the first driving part 2 to drive each of the first LEDs 1A under a first driving condition based on the video signal, and the second driving part 4 to drive the at least one second LED 3A under one of a plurality of second driving conditions determined in advance. The LED display control device 300 includes the luminance-drop-characteristics arithmetic part 21 configured to acquire a plurality of luminance drop characteristics by acquiring the results of measuring the luminances of the at least one second LED 3A driven under different second driving conditions and computing a luminance drop characteristic with respect to the accumulative lighting-up time of the at least one second LED 3A for each of the second driving conditions determined in advance, and the luminance correction part 22 configured to correct the luminance of video included in the video signal for each of the first LEDs 1A on the basis of one of the luminance drop characteristics and the accumulative lighting-up time of each of the first LEDs 1A. The LED display control device 300 performs control to cause the LED displays to display the video after the correction of the luminance on the one screen by distributing the video signals after the correction of the luminances to the LED displays 100.

The above configuration allows the LED display system to improve uniformity of the luminance and chromaticity of the first display parts 1 that display video or the like.

The luminance correction part 22 of the LED display system according to Embodiment 1 selects one of the luminance drop characteristics on the basis of the first driving condition.

The above configuration accurately improves the uniformity of the luminance and chromaticity of the first display parts 1.

In the LED display system according to Embodiment 1, the first driving condition includes the condition concerning duty ratios for PWM control of the first LEDs 1A. Each of the second driving conditions determined in advance includes the condition concerning duty ratios for PWM control of the at least one second LED 3A.

The above configuration allows the LED display system to precisely improve the uniformity in luminance and chromaticity caused by duty ratios.

The luminance correction part 22 of the LED display system according to Embodiment 1 includes the correction-coefficient arithmetic part 23 configured to calculate the first luminance correction coefficients for uniformly correcting the luminance of each of the first LEDs 1A on the one screen and further calculate the second luminance correction coefficients by correcting the first luminance correction coefficients on the basis of the accumulative lighting-up time of each of the first LEDs 1A in one luminance drop characteristic. The luminance correction part 22 corrects the luminance of the video included in the video signal for each of the plurality of first LEDs 1A by using the second luminance correction coefficients.

The above configuration allows the LED display system to improve the uniformity in the luminance and chromaticity of the first display parts 1.

In the LED display system according to Embodiment 1, the at least one second LED 3A has the same luminance drop characteristic as those of the plurality of first LEDs 1A when driven for the same period of time under the same driving condition as the first LEDs 1A.

The above configuration allows the LED display system to accurately obtain the luminance drop characteristics and to accurately improve the uniformity in the luminance and chromaticity of the first display parts 1.

### Embodiment 2

In Embodiment 1, the first driving part 2 of each LED display 100 drives each first LED 1A with fixed driving current. An LED display system according to Embodiment 2 corrects the luminance of the total LED display 200 by changing the driving currents of the LED displays 100.

The LED display system according to Embodiment 2 switches the driving current flowing through each first LED 1A between two types of modes: a high luminance mode and a normal luminance mode. A driving current value in the high luminance mode is greater than a driving current value in the normal luminance mode. During normal use, the system is operated in the normal luminance mode, and as necessary such as at an emergency, the system is switched to and operated in the high luminance mode. For example, in the case where the installation location of an LED display system used in an event or for other purposes is changed from a bright venue to a dark venue, the LED display system switches the above mode. As another example, in a case such as where the luminances of the first display parts 1 that light up in the high luminance mode are too high for observers to view, the LED display system switches the above mode. Conceivable cases such as where the observers have poor viewability include a case where the contents displayed on the first display parts 1 are changed from dark ones to bright ones.

In the case where the LED display system adjusts luminances with the two settings of the high luminance mode and the normal luminance mode, the first driving parts 2 adjust the luminances of a plurality of first LEDs 1A by changing the driving current values for these first LEDs 1A at the same time. In one luminance mode, the first LEDs 1A have the same driving current value.

In the high luminance mode, a temperature rise in the first LEDs 1A increases because of increased driving current flowing through the first LEDs 1A. Thus, the luminance drop rates with respect to the accumulative lighting-up times increase. Accordingly, the LED display system needs to measure the luminance drop rate of the second LEDs 3A in the high luminance mode and the luminance drop rate of the second LEDs 3A in the normal luminance mode.

In Embodiment 2, the LED display system controls each LED display 100 as follows. For example, the second LEDs 3A of the LED display 100 with ID numbers 1 to 6 are driven at a duty ratio of 100% in the normal luminance mode. The second LEDs 3A of the LED displays 100 with ID numbers 7 to 12 are driven at a duty ratio of 100% in the high luminance mode. The second LEDs 3A of the LED displays 100 with ID numbers 13 to 16 are driven at a duty ratio of 80% in the normal luminance mode. The second LEDs 3A of the LED displays 100 with ID numbers 17 to 24 are driven at a duty ratio of 80% in the high luminance mode. The second LEDs 3A of the LED displays 100 with ID numbers 25 to 30 are driven at a duty ratio of 60% in the normal luminance mode. The second LEDs 3A of the LED displays 100 with ID numbers 31 to 36 are driven at a duty ratio of 60% in the high luminance mode.

The luminance-drop-characteristics arithmetic part 21 acquires the luminance drop rate of the second LED 3A from each LED display 100 via the communication part 7. The luminance-drop-characteristics arithmetic part 21 generates luminance-drop-rate tables in the high luminance mode and luminance-drop-rate tables in the normal luminance mode on the basis of the current-carrying time and luminance drop rate of each LED display 100. At this time, the luminance-drop-characteristics arithmetic part 21 generates the luminance-drop-rate tables for each duty ratio. The parameter storage 25 stores the generated luminance-drop-rate tables. The luminance-drop-characteristics arithmetic part 21 updates the luminance-drop-rate tables at any time for each duty ratio over time. For example, the luminance-drop-characteristics arithmetic part 21 hourly receives the luminance drop rate from each LED display 100 and updates the luminance-drop-rate tables. There are six LED displays 100 for one duty ratio. The luminance-drop-characteristics arithmetic part 21 calculates an average value of six luminance drop rates obtained from the six LED displays 100 to generate each luminance-drop-rate table.

A luminance correction method in the case where the operation mode is fixed to either the high luminance mode or the normal luminance mode and the driving current for the driving parts is not switched is the same as that of Embodiment 1, and therefore a description thereof is omitted.

Next, a luminance correction operation performed by the LED display system will be described. The following description is given of the luminance correction operation performed by the LED display system in the case where the brightness of the first display parts 1 is adjusted in the mist of operation of the LED display system.

The correction-coefficient arithmetic part 23 obtains luminance drop rates of the total LED display 200 on the basis of the accumulative lighting-up time obtained by the lighting-up-time arithmetic part 24 and the luminance-drop-rate tables stored in the parameter storage 25. At this time, the correction-coefficient arithmetic part 23 obtains the luminance drop rates for the respective colors.

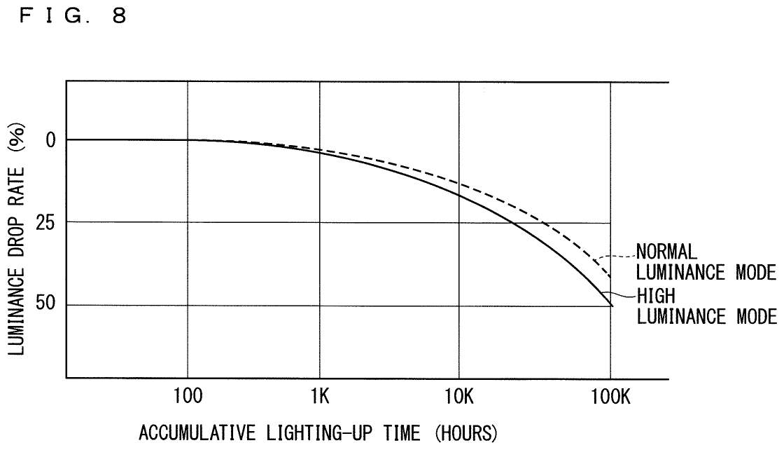

FIG. 8 is a diagram showing one example of luminance drop characteristics in the normal luminance mode and in the high luminance mode according to Embodiment 2. As the lighting-up time increases, the luminance drop rate of the second LEDs 3A increases. As described previously, a driving current value in the high luminance mode is greater than a driving current value in the normal luminance mode. Thus, heat load accompanying a temperature rise also becomes greater. The luminance drop rate of the second LEDs 3A that light up in the high luminance mode is higher than that of the second LEDs 3A that light up in the normal luminance mode.

As described previously, in the case where each first LED 1A of the first display part 1 and each second LED 3A have the same driving current value, each first LED 1A has a luminance drop rate similar to the luminance drop rate of each second LED 3A to the extent that both can be regarded as being identical.

The luminance of each first LED 1A decreases with increasing accumulative lighting-up time. When the luminance mode is switched from the high luminance mode to the normal luminance mode, the luminance drop characteristic of each first LED 1A transitions from the luminance drop characteristic in the high luminance mode to the luminance drop characteristic in the normal luminance mode. Even with the same accumulative lighting-up time, the luminance drop rate in the normal luminance mode differs from the luminance drop rate in the high luminance mode. Therefore, at the time of transition, if the luminances of the first LEDs 1A are corrected simply based on the luminance drop rate in the normal luminance mode after the elapse of the same accumulative lighting-up time, the luminance correction part 22 will obtain a correction result that differs from the progression of the actual luminance drop rates of the first LEDs 1A. That is, the luminance correction part 22 cannot accurately correct luminances.

In view of this, the LED display system according to Embodiment 2 converts the accumulative lighting-up times in the high luminance mode immediately before the change of the luminance mode into the corresponding accumulative lighting-up times in the normal luminance mode. This conversion allows the LED display system to accurately predict the luminance drop rates of the first LEDs 1A and to reduce variations in the luminance and chromaticity of the first display parts 1.

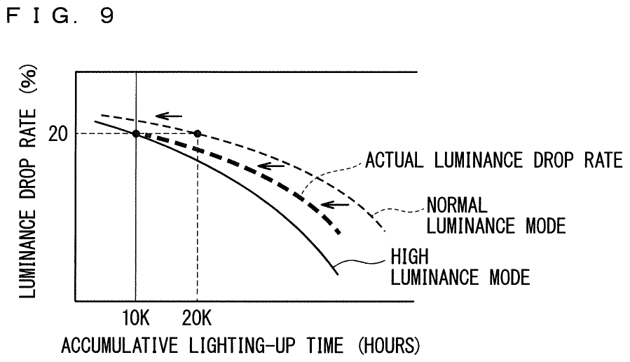

FIG. 9 is a diagram showing one example of luminance drop characteristics in the case where the luminance mode is switched according to Embodiment 2. As one example, only the luminance drop rates at a duty ratio of 100% with respect to the accumulative lighting-up times are illustrated in FIG. 9.

In the case where the first LEDs 1A light up in the high luminance mode and an accumulative lighting-up time T0 is 10K hours, the luminance drop rate is 20%. At T0=10K hours, the luminance mode is switched from the high luminance mode to the normal luminance mode. The correction-coefficient arithmetic part 23 calculates an accumulative lighting-up time T1 indicating a luminance drop rate of 20% from the graph showing the luminance drop rate in the normal luminance mode. That is, the correction-coefficient arithmetic part 23 calculates the accumulative lighting-up time in the normal luminance mode at which the luminance drop rate corresponding to the luminance drop rate in the high luminance mode is obtained. Here, T1 is 20K hours. Even if the luminance mode is switched from the high luminance mode to the normal luminance mode, the luminance drop characteristic in each luminance mode remains approximately the same. Therefore, after the accumulative lighting-up time of 10K hours, the luminances of the first LEDs 1A decrease along the luminance drop characteristic in the normal luminance mode after the accumulative lighting-up time T1 of 20K hours.

That is, in the case where the first LEDs 1A light up for 10K hours in the high luminance mode and then light up for 100 hours in the normal luminance mode, the first LEDs 1A exhibit the luminance drop rates when they light up for 20K hours+100 hours in the normal luminance mode. The correction-coefficient arithmetic part 23 obtains second luminance correction coefficients using the luminance drop rates when the first LEDs 1A light up for 20K hours+100 hours in the normal luminance mode.

Here, an example of obtaining an R luminance maintenance factor Pr(h, v) corresponding to Expression (10) is described. The R luminance maintenance factor Pr(h, v) is given by Expressions (21) to (23) below. In each of the following expressions, FPrh1(t) is an R luminance maintenance factor per accumulative lighting-up time at a duty ratio of 100% in the high luminance mode. FPrn1(t) is an R luminance maintenance factor per accumulative lighting-up time at a duty ratio of 100% in the normal luminance mode. Prh(h, v) is an R luminance maintenance factor for each pixel 10 in the high luminance mode. Prn(h, v) is an R luminance maintenance factor in the normal luminance mode.

Expression (21) gives the R luminance maintenance factor (h, v) in the high luminance mode in the case where Dr(h, v)=100%. Note that t0 is the accumulative lighting-up time in the high luminance mode.

Ph(h,v)=Prh(h,v)=FPrh1(t0) Expression (21)

Expression (22) gives the R luminance maintenance factor (h, v) in the normal luminance mode in the case where the luminance mode is switched from the high luminance mode to the normal luminance mode. The correction-coefficient arithmetic part 23 obtains T1 that satisfies Expression (22).

Prh(h,v)=FPrh1(t0)=FPrh1(T1) Expression (22)

Expression (23) gives the R luminance maintenance factor (h, v) after the switching to the normal luminance mode. Note that t1 is the accumulative lighting-up time after the switching to the normal luminance mode.

Pr(h,v)=Prn(h,v)=FPrh1(T1+t1) Expression (23)

The luminance modes in which the second LEDs 3A of the second display parts 3 are driven are not limited to two types of modes, i.e., the high luminance mode and the normal luminance mode. The LED display system may drive the second LED 3A of the LED displays 100 in three or more types of luminance modes.

Summary of Embodiment 2

In the case where the lighting control of the first LEDs 1A is switched from the high luminance mode to the normal luminance mode, an error occurs in the calculation of the accumulative lighting-up times of the first LEDs 1A after the switching of the luminance mode. This deteriorates the accuracy of correcting the luminances of the first LEDs 1A and causes variations in the luminance of the display of the first display parts 1.

In contrast, the LED display system according to Embodiment 2 converts the accumulative lighting-up times before the change of the luminance mode into the accumulative lighting-up times after the change of the luminance mode at the time of changing the luminance mode. This allows the LED display system to accurately predict the luminance maintenance factors of the first LEDs 1A and to reduce variations in the luminance and chromaticity of the first display parts 1.

The luminance correction part 22 is also capable of correcting luminances with reference to luminance-drop-rate tables stored in advance in the parameter storage 25 at the time of shipment from the factory. However, drops in the luminances of the first LEDs 1A vary depending on environmental temperatures or other factors. The presence of the second display part 3 for measuring luminances in each LED display 100 as in Embodiment 2 improves the accuracy of luminance correction.

Even in the case where the second LEDs 3A of one LED display 100 are driven at different duty ratios in different luminance modes (driving current values), it is possible to obtain the luminance-drop-rate tables for each luminance mode and for each duty ratio in the same manner. This, however, complicates a sequence of measuring the luminance of each second LED 3A. In Embodiment 2, the second LEDs 3A of one LED display 100 are driven at one duty ratio and in one luminance mode (one driving current value). Then, the LED display control device 300 collects the results of measuring the luminances of the second LEDs 3A driven at different duty ratios from a plurality of LED displays 100 and calculates a plurality of luminance drop characteristics. This simplifies the sequence of measuring the luminance of one LED display 100.

In summary, the first driving condition in the LED display system according to Embodiment 2 includes a condition concerning a driving current for driving the plurality of first LEDs 1A. Each of the second driving conditions determined in advance includes a condition concerning a driving current for driving the at least one second LED 3A.

This configuration allows the LED display system to accurately improve the uniformity in the luminance and chromaticity even in the case where the luminances of the first display parts 1 are adjusted in the midst of operation by changing the driving current of the first LEDs 1A.

### Embodiment 3

An LED display system according to Embodiment 3 is a superordinate concept of the LED display system according to Embodiment 1 or 2. That is, the LED display system according to Embodiment 1 or 2 includes each configuration included in the LED display system according to Embodiment 3. Note that a description of configurations and operations similar to those of Embodiment 1 or 2 is omitted.

FIG. 10 is a block diagram illustrating an internal configuration of one LED display 101 according to Embodiment 3. The LED display 101 includes a first display part 1, a first driving part 2, a second display part 3, a second driving part 4, and a luminance measurement part 5.

The first display part 1 includes a plurality of first LEDs provided on a display surface. The first driving part 2 drives each of the first LEDs under a first driving condition based on a video signal. The video signal is, for example, input from a later-described LED display control device 301 via a video-segmentation transfer circuit 40.

The second display part 3 includes at least one second LED provided on a surface different from the display surface. The second driving part 4 drives the at least one second LED under one of a plurality of second driving conditions determined in advance. The luminance measurement part 5 measures the luminance of the at least one second LED. For example, the luminance measurement part 5 outputs the result of the measurement to the LED display control device 301 via an internal communication controller 27A. The configuration and function of the internal communication controller 27A is the same as those of the internal communication controller 27 in Embodiment 1.

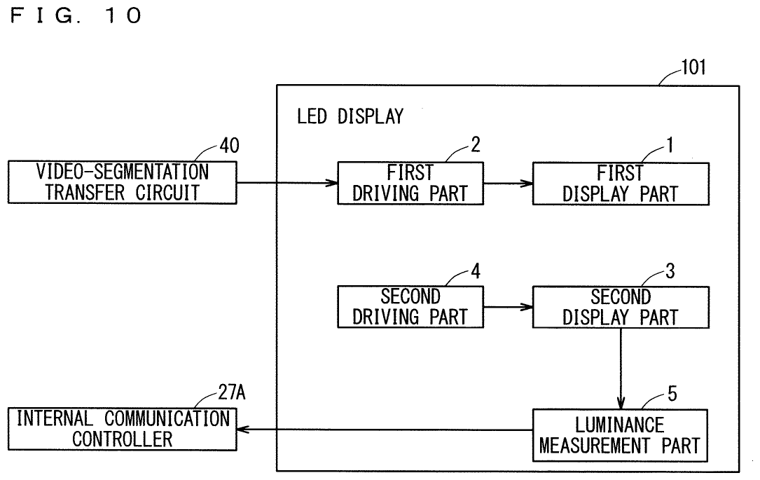

FIG. 11 is a block diagram illustrating an internal configuration of the LED display control device 301 according to Embodiment 3. The LED display control device 301 includes a luminance-drop-characteristics arithmetic part 21 and a luminance correction part 22.

The luminance-drop-characteristics arithmetic part 21 acquires the result of measuring the luminance of the at least one second LED, each driven under different second driving conditions, from the plurality of LED displays 101. For example, the luminance-drop-characteristics arithmetic part 21 acquires luminance measurement results via the internal communication controller 27A. The luminance-drop-characteristics arithmetic part 21 acquires a plurality of luminance drop characteristics by computing a luminance drop characteristic of the at least one second LED with respect to accumulative lighting-up times for each of a plurality of second driving conditions determined in advance.

The luminance correction part 22 corrects the luminance of video included in the video signal for each of the first LEDs on the basis of one of the luminance drop characteristics and the accumulative lighting-up times of the first LEDs. The LED display control device 301 performs control to cause the LED displays 101 to display video after the correction of the luminance on one screen, by distributing the video signal after the correction of the luminance to the first driving part 2 of each of the LED displays 101. For example, the LED display control device 301 distributes the video signal after the correction of the luminance to each first driving part 2 via the video-segmentation transfer circuit 40. Note that the video signal before luminance correction is input from, for example, a video-signal processing circuit 30.

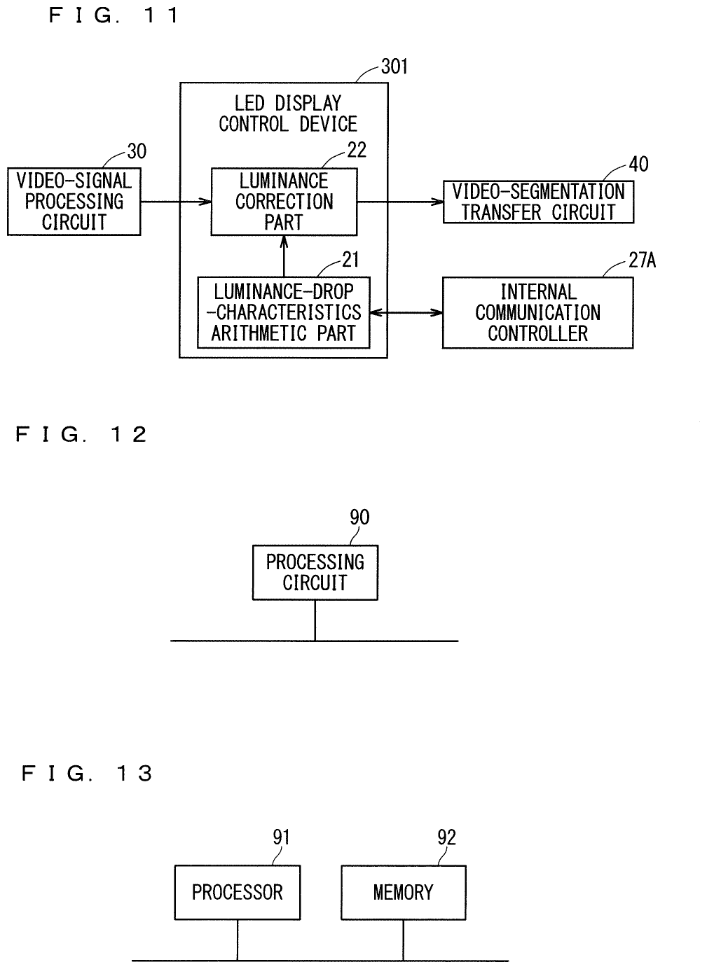

FIG. 12 is a diagram showing one example of a processing circuit 90 included in the LED display control device 301. Each function of the luminance-drop-characteristics arithmetic part 21 and the luminance correction part 22 is implemented by the processing circuit 90. That is, the processing circuit 90 includes the luminance-drop-characteristics arithmetic part 21 and the luminance correction part 22.

In the case where the processing circuit 90 is dedicated hardware, the processing circuit 90 is, for example, a single circuit, a complex circuit, a programmed processor, a parallel-programmed processor, an application specific integrated circuit (ASIC), a field-programmable gate array (FPGA), or any combination of these circuits. Each function of the luminance-drop-characteristics arithmetic part 21 and the luminance correction part 22 may be implemented separately by a plurality of processing circuits, or may be implemented collectively by a single processing circuit.

FIG. 13 is a diagram showing another example of the processing circuit included in the LED display control device 301. The processing circuit includes a processor 91 and a memory 92. Each function of the luminance-drop-characteristics arithmetic part 21 and the luminance correction part 22 is implemented by the processor 91 executing programs stored in the memory 92. For example, each function is implemented by the processor 91 executing software or firmware described as programs. That is, the LED display control device 301 includes the memory 92 that stores programs and the processor 91 that executes the programs.

In the program, a function is written in which the LED display control device 301 acquires the plurality of luminance drop characteristics by acquiring the result of measuring the luminance of the at least one second LED, each driven under different second driving conditions, from the plurality of LED displays 101 and computing the luminance-drop characteristic of the at least one second LED with respect to the accumulative lighting-up time for each of the plurality of second driving conditions determined in advance. A function is further written in which the LED display control device 301 corrects the luminance of video included in the video signal for each of the plurality of first LEDs on the basis of one of the luminance-drop characteristics and the accumulative lighting-up time of each of the first LEDs. A function is further written in which the LED display control device 301 performs control to cause the plurality of LED displays 101 to display the video after the correction of the luminance on the one screen by distributing the video signal after the correction of the luminance to the first driving part 2 of each of the LED displays 101. The program causes a computer to execute the procedure or method of the luminance-drop-characteristics arithmetic part 21 and the luminance correction part 22.

Examples of the processor 91 include a central processing part, a processing unit, an arithmetic unit, a microprocessor, a microcomputer, and a digital signal processor (DSP). Examples of the memory 92 include nonvolatile or volatile semiconductor memories such as a random access memory (RAM), a read only memory (ROM), a flash memory, an erasable programmable read only memory (EPROM), and an electrically erasable programmable read only memory (EEPROM). The memory 92 may also be any of various types of storage media that may be used in the future, such as a magnetic disk, a flexible disk, an optical disk, a compact disk, a minidisc, or a DVD.

Alternatively, part of each function of the luminance-drop-characteristics arithmetic part 21 and the luminance correction part 22 described above may be implemented by dedicated hardware, and the other part of the function may be implemented by software or firmware. In this way, the processing circuit implements each of the aforementioned functions by hardware, software, firmware, or any combination of them.

Note that embodiments of the present invention may be freely combined or appropriately modified or omitted within the scope of the disclosure.

While the invention has been shown and described in detail, the foregoing description is in all aspects illustrative and not restrictive. It is therefore understood that numerous modifications and variations can be devised without departing from the scope of the invention.

### EXPLANATION OF REFERENCE SIGNS

1: first display part, 1A: first LED, 2: first driving part, 3: second display part, 3A: second LED, 4: second driving part, 5: luminance measurement part, 21: luminance-drop-characteristics arithmetic part, 22: luminance correction part, 23: correction-coefficient arithmetic part, 100: LED display, 101: LED display, 300: LED display control device, 301: LED display control device.

1. An LED display system comprising:
a plurality of LED displays arranged in a matrix and each having a display surface, the display surfaces of the plurality of LED displays being arranged to form one screen; and
an LED display control device to preform control to cause the plurality of LED displays to display video on the one screen by distributing a video signal to the plurality of LED displays, wherein
each of the plurality of LED displays includes:
a first display part including a plurality of first LEDs provided on the display surface;
a second display part including at least one second LED provided on a surface different from the display surface;
a luminance measurement part to measure a luminance of the at least one second LED;
a first driver to drive each of the plurality of first LEDs under a first driving condition based on the video signal; and
a second driver to drive the at least one second LED under one second driving condition among a plurality of second driving conditions determined in advance,
the LED display control device includes:
a processor to execute a program; and
a memory to store the program which, when executed by the processor, causes the processor to perform processes of
acquiring a plurality of luminance drop characteristics by acquiring a result of measuring the luminance of the at least one second LED, each driven under different second driving conditions, from the plurality of LED displays and computing a luminance drop characteristic of the at least one second LED with respect to an accumulative lighting-up time for each of said plurality of second driving conditions determined in advance;
correcting a luminance of the video included in the video signal for each of the plurality of first LEDs on the basis of one luminance drop characteristic among the plurality of luminance drop characteristics and an accumulative lighting-up time of each of the plurality of first LEDs,
calculating a first luminance correction coefficient for uniformly correcting a luminance of each of the plurality of first LEDs on the one screen and further calculating a second luminance correction coefficient by correcting the first luminance correction coefficient on the basis of the accumulative lighting-up time of each of the plurality of first LEDs in the one luminance drop characteristic, and
correcting the luminance of the video included in the video signal for each of the plurality of first LEDs by using the second luminance correction coefficient, and
the LED display control device performs control to cause the plurality of LED displays to display the video after the correction of the luminance on the one screen by distributing the video signal after the correction of the luminance to the plurality of LED displays.

2. The LED display system according to claim 1, wherein
the processes performed by the processor further include
selecting the one luminance drop characteristic from among the plurality of luminance drop characteristics on the basis of the first driving condition.

3. The LED display system according to claim 1, wherein
the first driving condition includes a condition concerning duty ratios for PWM control of the plurality of first LEDs, and
the plurality of second driving conditions determined in advance includes a condition concerning duty ratios for PWM control of the at least one second LED.

4. The LED display system according to claim 1, wherein
the first driving condition includes a condition concerning a driving current for driving the plurality of first LEDs, and
the plurality of second driving conditions determined in advance includes a condition concerning a driving current for driving the at least one second LED.

5. (canceled)

6. The LED display system according to claim 1, wherein
when the at least one second LED is driven for the same amount of time under the same driving condition as the plurality of first LEDs, the at least one second LED exhibits the same luminance drop characteristic as the luminance drop characteristic of the plurality of first LEDs.

7. (canceled)

8. An LED display control device in an LED display system that includes a plurality of LED displays arranged in a matrix and each having a display surface, the display surfaces of the plurality of LED displays being arranged to form one screen, and the LED display control device to perform control to cause the plurality of LED displays to display video on the one screen by distributing a video signal to the plurality of LED displays,
each of the plurality of LED displays including:
a first display part including a plurality of first LEDs provided on the display surface;
a second display part including at least one second LED provided on a surface different from the display surface;
a luminance measurement part to measure a luminance of the at least one second LED;
a first driver to drive each of the plurality of first LEDs under a first driving condition based on the video signal; and
a second driver to drive the at least one second LED under one second driving condition among a plurality of second driving conditions determined in advance,
the LED display control device comprising:
a processor to execute a program; and
a memory to store the program which, when executed by the processor, causes the processor to perform processes of
acquiring a plurality of luminance drop characteristics by acquiring a result of measuring the luminance of the at least one second LED, each driven under different second driving conditions, from the plurality of LED displays and computing a luminance drop characteristic of the at least one second LED with respect to an accumulative lighting-up time for each of the plurality of second driving conditions determined in advance,
correcting a luminance of the video included in the video signal for each of the plurality of first LEDs on the basis of one luminance drop characteristic among the plurality of luminance drop characteristics and the accumulative lighting-up time of each of the plurality of first LEDs,
calculating a first luminance correction coefficient for uniformly correcting a luminance of each of the plurality of first LEDs on the one screen and further calculating a second luminance correction coefficient by correcting the first luminance correction coefficient on the basis of the accumulative lighting-up time of each of the plurality of first LEDs in the one luminance drop characteristic, and
correcting the luminance of the video included in the video signal for each of the plurality of first LEDs by using the second luminance correction coefficient, and
the LED display control device performs control to cause the plurality of LED displays to display the video after the correction of luminance on the one screen by distributing the video signal after the correction of the luminance to the plurality of LED displays.
